(19) United States
(12) Patent Application Publication
(10) Pub. No.: US 2019/0114943 A1
(43) Pub. Date: Apr. 18, 2019

(54) DESCRIPTIVIST LANGUAGE LEARNING SYSTEM AND METHOD

(71) Applicant: KEITH PHILLIPS, ANN ARBOR, MI (US)

(72) Inventor: KEITH PHILLIPS, ANN ARBOR, MI (US)

(21) Appl. No.: 15/786,567

(22) Filed: Oct. 17, 2017

(51) Int. Cl. G09B 19/06; G09B 5/06; G09B 7/07; G09B 7/02; G09B 5/12

(52) U.S. Cl. CPC G09B 19/06; G09B 5/06; G09B 5/125; G09B 7/02; G09B 5/12; G09B 7/07

(57) ABSTRACT

The present invention is a descriptivist language learning method and system. The present invention records a conversation by two native-speakers in a target language. The conversation is transcribed and translated. The transcribed and translated versions are both segmented into snippets that last between thirty (30) seconds and five (5) minutes. A concordance is created from the transcribed segmented conversation. A pareto distribution is created from the concordance. A set of high-frequency, non-trivial words and phrases are defined by the pareto distribution. A language learning application teaches a student the target language by presenting language learning exercises to the student which concentrate on the high-frequency, non-trivial words.

### FIELD OF INVENTION

This invention relates to the class of education and demonstration and one or more sub-classes related to language. Specifically, this invention relates to a foreign language learning system and method.

### BACKGROUND OF INVENTION

There are approximately 7000 living languages extant today. Of those, approximately twenty-six languages have 50 million or more total speakers, according to the 2017 edition of ETHNOLOGUE: LANGUAGES OF THE WORLD, published by SIL International: Mandarin Chinese, English, Hindustani (Hindi/Urdu), Spanish, Arabic, Malay, Russian, Bengali, Portuguese, French, Hausa, Punjabi, Japanese, German, Persian, Swahili, Telugu, Javanese, Wu Chinese, Korean, Tamil, Marathi, Yue Chinese (Cantonese), Turkish, Vietnamese, and Italian (“Most Spoken Languages”).

Learning a new language with conventional techniques is a time-consuming task. The United States Department of State estimates that it takes 4400 hours to become proficient in a new language. The Common European Framework of Reference for Language (“CERF”) estimates that, between Guided Learning Hours (“GLH”) and personal study hours, it takes 1000-1200 hours to achieve proficiency in a new language. The American Council on Teaching Foreign Language (“ACTFL”) estimates that it takes 960 hours, between GLH and personal study hours, to achieve mid-level proficiency in a Romance language (e.g., French, Spanish, and Portuguese). According to the American Defense Language Institute, where the United States' Central Intelligence Agency teaches officers and agents foreign languages, between 1500 and 4000 hours are needed to learn a new language, when accounting for both instructional time and study time.

The time-commitment required to achieve proficiency inhibits learning and reduces success rates. Many students abandon a new language program shortly after joining, because the time-commitment needed to achieve proficiency is overwhelming. Moreover, the substantial time-commitment required to learn a language makes it impractical for people who are travelling for business or pleasure to learn a language prior to their trip. The lead-time required to learn a new language using traditional methods creates a significant disincentive to learning a new language when travel is only weeks or months in the future.

Traditional methods are abstract, by design, starting with grammar and declensions rather than conversation. By focusing on the abstract constructs of language, traditional methods tend to inhibit language acquisition. Additionally, teaching abstract concepts such as grammar and declensions increases the raw volume of information that must be mastered prior to a student becoming fluent. Another complaint about traditional methods for teaching foreign language is that they teach many concepts that are of dubious use. For example, teaching one about the post office in the internet age is often a waste of time.

Newer methods, such as interactive immersion, use computer exercises in an attempt to speed language acquisition. Interactive immersion allows a user to interact with various multi-person scenes, while being presented with the language corresponding to the scene from each person's perspective. Unfortunately, interactive immersion still depends heavily on teaching grammar and contextualizing conversations in an abstract manner.

When humans learn their first language, they are not immediately taught grammar and declensions. Additionally, toddlers acquiring language are not given artificial abstractions to contextualize grammar. Research data shows that people learn their first language by natural repetition. Language is assimilated in small segments, called snippets, usually between one and three minutes in length. In practice, the lower limit will be around thirty (30) seconds and the upper limit will be five (5) minutes. People learn the most commonly used words first and start speaking when they can use common words in a logical thought.

No current method replicates the natural language acquisition method of humans: namely, repetitively presenting the most common words in a variety of contexts to allow the student to master the most important words in a language. A pareto analysis of word-use shows that 80% or more of the content of a native speaker of a language is encompassed in as little as 1,000 (one thousand) words (“high-use pareto”). It is this aspect of the language-acquisition Pareto-Effect that allows toddlers to acquire language so quickly. By focusing a system and method on the content of the high-use pareto, students learn language more quickly in a much more natural, familiar, and organic fashion.

### SUMMARY OF THE INVENTION

This summary is intended to illustrate and teach the present invention, and not limit its scope or application. The present invention is a descriptivist system and method for language learning. The target language is the language that is being learned. The base language is the language the student speaks natively. The descriptivist system and method for language learning can be used to teach a student who speaks a Most Spoken Language as a base language a different Most Spoken Language as a target language. Additionally, the descriptivist system and method for language learning can be used to teach a student who speaks any of the approximately 7,000 languages as a base language another one of the approximately 7,000 languages as a target language.

The descriptivist system and method for language learning starts with a conversation involving a plurality of persons (“Native-speakers”) conversant in a target language. The conversation is not scripted, but guidelines are given to the Native-speakers. The guidelines identify topics that should be discussed by the Native-speakers, without dictating the content of the discussion. At least one such conversation of Native-speakers is recorded and captured on a server and database. A server is a collection of processors and associated circuitry upon which a software instruction set can executed. A database is a collection of memory elements which interoperates with the server and software instruction set. The server and database may be physically separated, in which case the server communicates with the remote database. The server and database can also be physically connected or be resident in the same assembly. The database may be internal to the server or it may be external to the server, such as a cloud repository. In this application, the cloud refers to a plurality of vendorized memory and server elements that are accessible to a user via the internet.

The at least one recorded conversation is transcribed in the target language and translated into a base language. The base language is a language with which the user of the present invention, a student, is familiar. Once the at least one conversation is transcribed and translated, both versions of the conversation are segmented into logical blocks of between one and three minutes in length. In no event should the logical blocks be less than 30 (thirty) seconds in duration, nor more than five minutes in duration. The at least one transcribed and segmented conversation is used to create a concordance. The concordance is an alphabetical list of the non-trivial words and phrases (La the words and phrases that give meaning to the conversation) present within the at least one segmented and transcribed target language conversation, with reference to the passage(s) where the word or phrase occurred. The target language concordance is used to create a pareto distribution of the frequency with which words and phrases are used. The words and phrases are rank ordered in the pareto distribution. A pre-defined threshold is established. The pre-defined threshold is either a word count or a percentage. The words or phrases that are above the pre-defined threshold are referred to as the high-frequency words and phrases.

The pareto distribution, concordance, segmented conversations, translated conversations, and transcribed conversations are used to identify and create the content. The content is presented to the student emphasizing the high-frequency words and phrases. This analytics process outputs a descriptivist method of language learning called the captured content.

The descriptivist method of language learning is used within a system. The system includes a server and database on which the descriptivist language learning method resides; a user electronic device; a means for communicating between the user electronic device and the server and database; and the captured content. A user interacts with the descriptivist language learning method using an application resident on the user's electronic device, or via an internet-based application, such as a web page. The user's electronic device can be a cellphone, tablet, computer, or wearable electronic (e.g., smart watch). The user's electronic device has a processor, a memory element with non-transitory computer readable medium, an input means, a communication means allowing it to send and receive information. The user's electronic device is capable of connecting to the internet, either directly (e.g., an ethernet cable or Wi-Fi) or through a communications network, such as a cellular network.

The student is exposed to the captured content, emphasizing the transcribed and segmented recordings of actual Native-speakers. The frequency with which a student encounters a word or phrase is based on the pareto distribution of the captured content. The student learns aural skills by listening to the transcribed segmented recordings in a 1-2-1 sequence (one time before completing associated practice activities, two times during the practice activities, and one time following the practice activities).

Written practice activities are also presented to the student. The written practice activities are conducted in the target language, and involve both vocabulary and grammar activities. Written practice activities include, but are not limited to, word matching between the target and base language, partial word completion in the target language, fill-in-the-blank, and multiple choice. The vocabulary in the practice activities are presented with a frequency that approximates the pareto distribution. Practice activities also include oral skills, which are built by repeating select portions of the segmented, transcribed recordings. The written and oral portions of the practice activities prepare students to practice the target language by building cognitive skills, focusing on the words that are most used in the target language. The student's cognitive and language production skills are built using words, phrases, and grammatical segments from the transcribed recordings of the target language using contextual completion and individual modification. Contextual completion means filling-in phrases or sentences with logical grammar from the target language using the context presented. Individual modification means completing information in a phrase or sentence using personal information. This would include such activities as completing phrases with language appropriate to the student's gender.

In order to access the application, the student logs in on their electronic device. The student is presented with a plurality of learning modules, and may open the module of their choosing. The application begins the module either from the beginning or from where the student left off during a previous session, whichever is appropriate. The student works on the activity until completion or until the student disengages. The application records the student's answers. The application has service interrupts in all modules, allowing the student to exit the application at any time.

The application tracks, guides, and rewards the student's progress by calculating the student's completion and success rates. By analyzing the student's progress, the application suggests activities to be repeated.

The captured content is the translated and segmented conversations, wherein the frequency of presentation is based on the analytics of the concordance and pareto distribution. The captured content is hosted on the server and database. The captured content is presented to the student using a user interface (UI), creating a user experience (UX).

The presentation (UI, UX) is made to the student's mobile device or computer. The student's electronic device communicates with the server and database via a communication system using the internet, cellular service, or a combination of both. The student's electronic device is communication enabled through the internet and/or through a cellular network.

The captured content is presented (UI, UX) to the student's electronic device using an application. The captured content is processed so that the high-frequency words and phrases are highlighted. The high-frequency words and phrases are defined by the pareto distribution. The highlighting can take many forms, including, but not limited to: displaying the high-frequency word with bold text; changing the color of the high-frequency word; creating a highlight on the background adjacent to the high-frequency word; and italicizing the high-frequency word.

The application calculates success rates and exposure during a session and overall. The user's success rates and exposure are processed and shown to the user through the UI, UX. The user success rates are processed with a machine-learning algorithm via natural language processing (“NLP”). The processed success rates are fed to a module of the application, that adjusts the captured content that is presented to the student based off of the student's progress. The content adjusting can take one of two implementations. The exposure rate of particular high-frequency words and phrases to the user can be increased or decreased based off the success rate. For example, as the student gains proficiency, the application will reduce presentation of the highest frequency words, provided the student has cognitive understanding of the words. Words and phrases with a lesser frequency will then be added into the rotation of the captured content that is presented to the student. The new exposure rates can then be fed back to the captured content. The highlighting of high-frequency words and phrases can also be modified to emphasize certain content to the user. For example, if a student repetitively misses a particular word or phrase, the highlighting can be both bolded and presented in a different color of text. The new highlighting scheme can be fed back to the captured content.

The application can be written in a traditional server and client manner, or it can be written so that the application is totally resident on the cloud and a student merely accesses the application through web pages on a web-portal. As the particular architecture of the software components is not part of the claimed invention, it is left to those skilled in the arts to select the most appropriate method for their particular implementation.

### BRIEF DESCRIPTION OF THE DRAWINGS

The present invention, a descriptivist system and method for language learning, is illustrated with five drawings on five sheets.

FIG. 1 is a high-level communication system flow of the present invention.

FIG. 2 is a high-level language-capture flow of the present invention.

FIG. 3 shows a high-level timeline of the present invention's learning process.

FIG. 4 is high-level flow chart of the present invention.

FIG. 5 is a high-level system flow chart.

### DETAILED DESCRIPTION OF THE DRAWINGS

The following descriptions are not meant to limit the invention, but rather to add to the summary of invention, and illustrate the present invention, a descriptivist system and method for language learning. The descriptivist system and method for language learning presented with the drawings of this specification is but one potential embodiment. Those skilled in the art are able to take the disclosure provided herein to create additional embodiments.

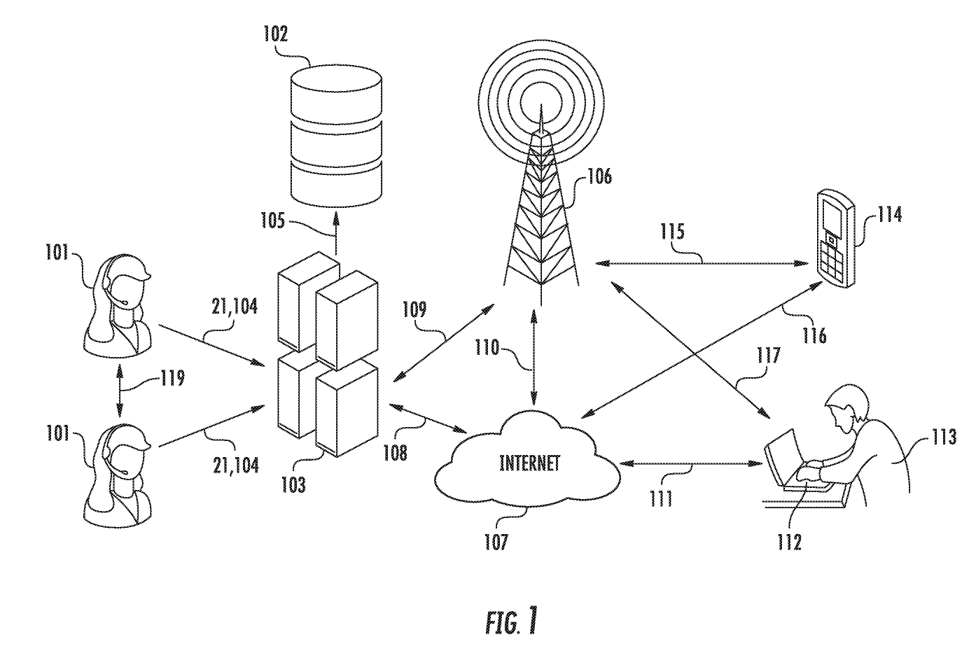

The descriptivist system and method for language learning can be used to teach a student who speaks a Most Spoken Language as a base language a different Most Spoken Language as a target language. In its most general form, the descriptivist system and method for language learning can be used to teach a student who speaks any of the approximately 7,000 languages as a base language another one of the approximately 7,000 languages as a target language. FIG. 1 is a high-level system flow-chart of the present invention 100, a descriptivist system and method for language learning. The high-level communication flow-chart is accomplished with circuitry and software, which is a computer readable instruction set stored on a non-transitory, computer-readable medium. The circuitry and software enable the present invention 100.

The descriptivist system and method for language learning 100 is intended to teach a target language to a non-native speaking student 113. The non-native speaking student's 113 language is referred to as the base language. The descriptivist system and method for language learning 100 starts with a plurality of persons (“Native-speakers”) 101 conversant in a target language. At least one conversation 119 of native-speakers 101 is recorded 104 and captured on a server 103. The Native-speakers are provided guidelines for the conversation, said guidelines emphasizing topics which should be discussed, rather than words or phrases that are to be used. The server 103 communicates 105 with a database 102. The database 102 may be internal to the server 103 or it may be external to the server, such as a cloud repository, accessible to the student 113 via the internet 107.

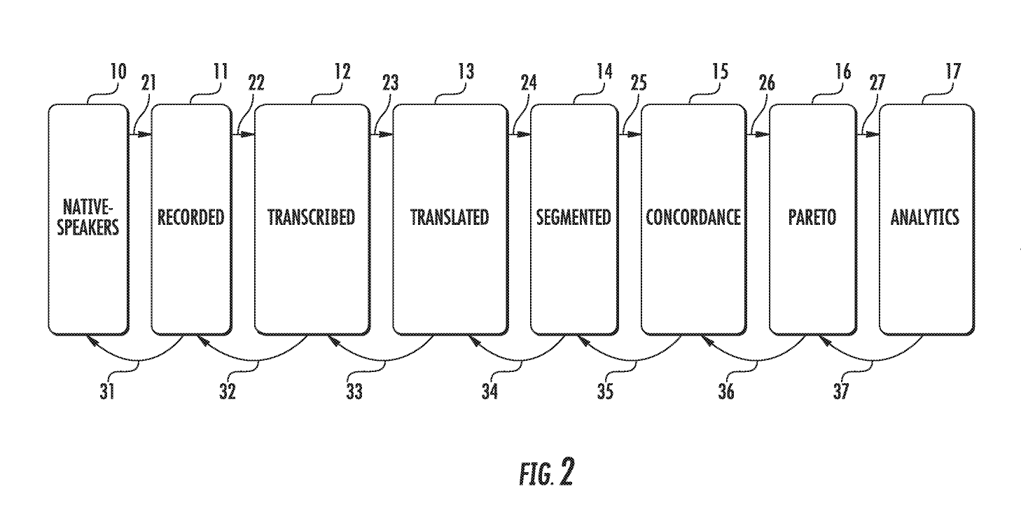

FIG. 2 shows the language-capture method flow-chart of the present invention 100. The native-speakers 101 conversation is transmitted 21 in a manner which allows it to be recorded 104. The at least one conversation is copied and transmitted 22, 23 in a manner which allows it to be transcribed 12 in the target language and translated 13 into the base language, by a transcription 12 module and a translation 13 module, respectively. At this point, the conversation exists as both a recorded transcription 12 (target language) and a recorded translation 13 (base language). Once the at least one conversation is transcribed 12 and translated 13, both versions of the conversation are copied and transmitted 24 in a manner which allows them to be segmented 14 into logical blocks, or snippets, usually between one and three minutes in duration, by a segment module 14. In practice the lower limit for the segments will be thirty (30) seconds and the upper limit will be five minutes. The transcribed 12 and segmented 14 conversation is copied and transmitted 25 in a manner which allows a concordance 15 to be created by a concordance module 15. The concordance 15 created from the transcribed 12 and segmented 14 conversation is an alphabetical list of the non-trivial words (i.e. the words and phrases that give meaning to the conversation) present within the segmented 14 and transcribed 12 target language conversation, with reference to the passage(s) to where the word occurred. The target language concordance 15 is copied and transmitted 26 in a manner which allows a pareto distribution 16 to be created by a pareto distribution module 16. A pareto distribution 16 is a word-count frequency distribution, identifying which words in the transcribed 12 and segmented 14 target language conversation are most used. The words and phrases are put in rank order, by occurrence, in the pareto distribution 16. The pareto distribution 16 is copied and transmitted 27 to an analytics 17 module.

The analytics 17 module uses data from the pareto distribution 37, 16; the concordance 36, 15; the segmented conversations 35, 15; the translated 34, 13 conversations; the transcribed 33, 12 conversations; and the recorded 32, 104 conversations of the native speakers 31, 101. The analytics 17 module creates an interactive descriptivist system and method 100.

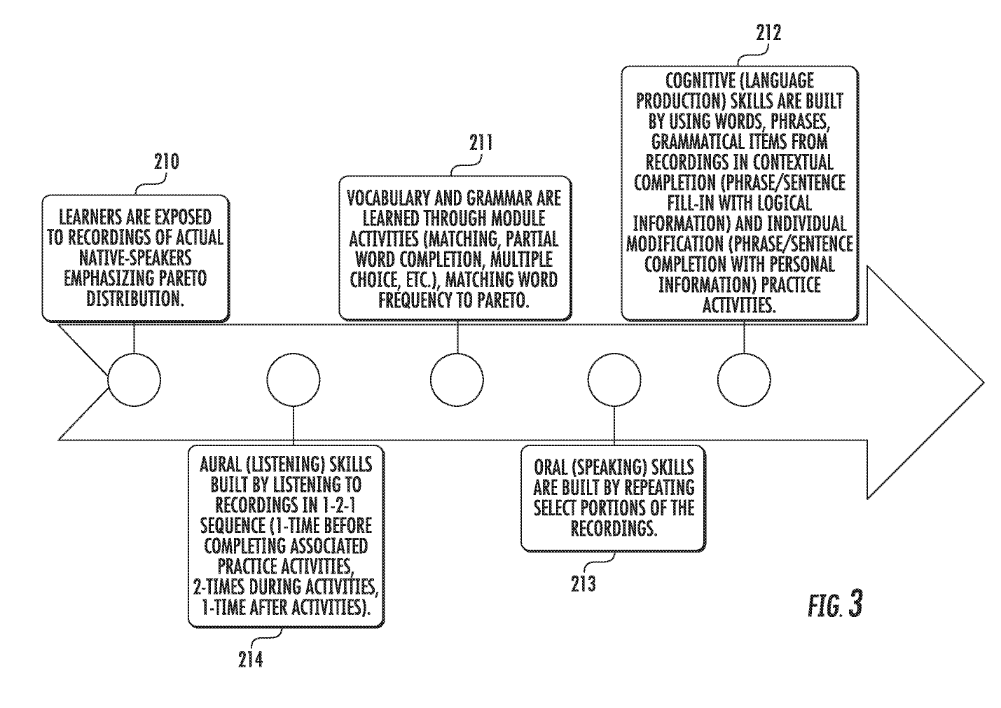

FIG. 3 is a high-level timeline of the learning method for a student 113. Initially 210, the learners 113 are exposed to transcribed 12 segmented recordings 14 of actual native speakers 101 emphasizing the pareto distribution 16. Next 214, the student 113 builds aural skills by listening to the transcribed 12 segmented 14 recordings. The student 113 listens to the transcribed 12 segmented 14 recordings in a 1-2-1 sequence (one time before completing associated practice activities, two times during the practice activities, and one time following the practice activities).

The written portion of the practice activities 211 are vocabulary and grammar activities, conducted in the target language, such as matching, partial word completion, and multiple choice. The vocabulary in the practice activities 211 are presented in a frequency that matches the pareto distribution 16. Practice activities also include oral skills 213, which are built by repeating select portions of the recordings. The written portion 211 and oral portion 213 of the practice activities prepare students 113 to practice the target language by building cognitive skills 212. The student's 113 cognitive skills 212, or language production skills 212, are built using words, phrases, and grammatical segments 14 from recordings 104 in contextual completion and individual modification. Contextual completion means filling-in phrases or sentences with logical grammar from the target language using the context presented. Individual modification means completing phrase or sentence information using personal information.

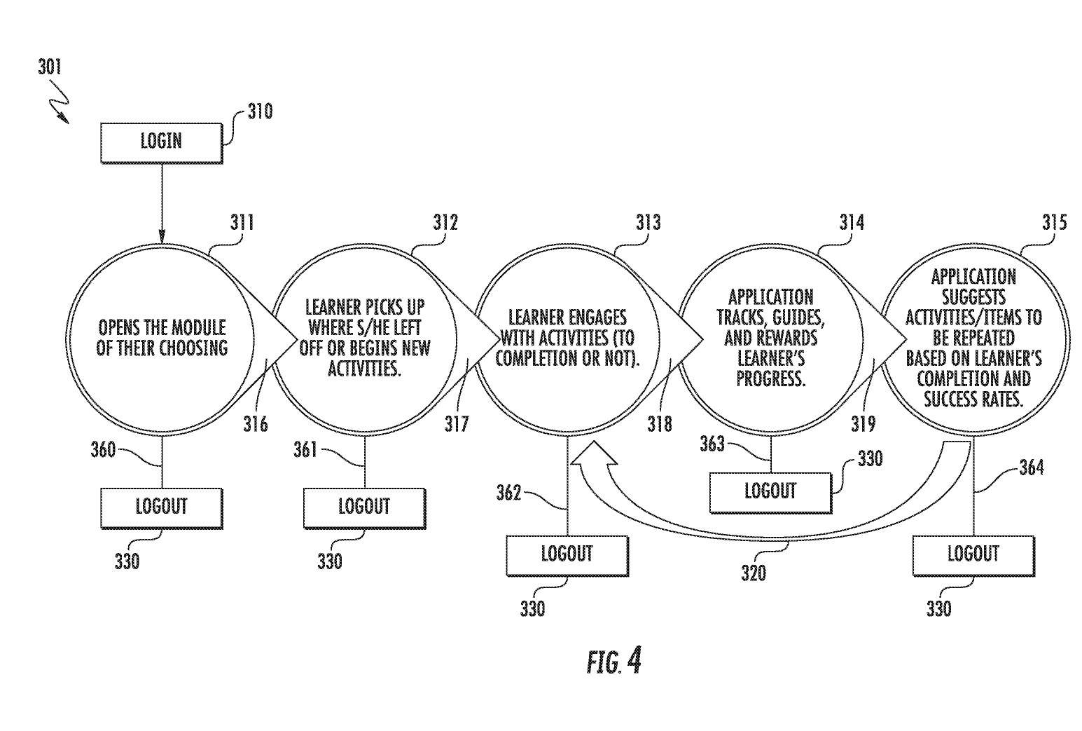

FIG. 4 is a high-level logic flow for a programmatic implementation 301 of the learning process for a student 113. The student 113 logs in 310. The student 113 is presented multiple modules, and may open the module of their choosing 311. The module opens 316 and either takes the student 113 to where the student 113 left off in the module during a previous session; or presents the student with an activity from the beginning of the module 312. The student 113 begins the activity where presented 317 and engages with the activity until completion or until the student 113 disengages 313. The application receives activity-based inputs 318 from the student 113, allowing the application to track, guide, and reward the student's progress 314. By analyzing 319 the student's 113 progress, based on the student's 113 individual completion and success rates, the application suggests activities to be repeated 315, 320. The programmatic implementation 301 of the descriptivist system and method 100 has a plurality of service interrupts 360, 361, 362, 363, 364, allowing the user to stop the programmatic implementation 301 by logging out 330.

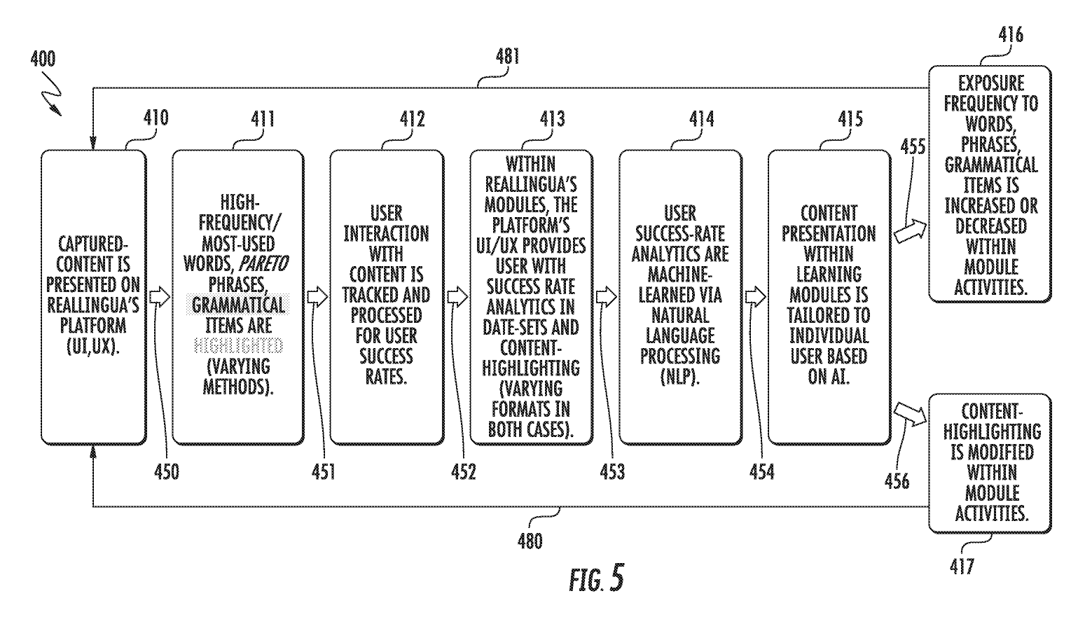

FIG. 5 is a high-level system 400 flow-chart. This discussion will also reference the high-level system communication flow of FIG. 1, language-capture method flow-chart of FIG. 2, and the high-level logic flow for a programmatic implementation 301 of FIG. 4. The captured content 410 is the translated 13 and segmented 14 conversations, presented based on analytics 17 of the concordance 15 and pareto distribution 16. The captured content 410 is hosted on a server 103 and database 102 and is presented to the student 113 using a user interface (UI), creating a user experience (UX). The presentation (UI, UX) is made via the programmatic implementation 301.

The presentation (UI, UX) is made to the student 113 on a mobile device 114 or computer 112. The student's 113 electronic device 114, 112 communicates 111, 115, 116, 117, 110, 109, 108 with the server 103 and database 102 via a public communication system 111, 115, 116, 117, 110, 109, 108, 107, 106 using the internet 107, cellular service 106, or a combination of both internet 107 and cellular service 106. The student's 113 electronic device 114, 112 is communication enabled 111, 115, 116, 117, 110, 109, 108, through the internet 107 and/or through a cellular network 106. Although not shown, the student's 113 electronic device can also be a tablet or a wearable electronic, such as a smart watch. The student's electronic device 114, 112 has a processor, a memory element with non-transitory computer readable medium, an input means, a communication means allowing it to send and receive information.

The captured content 410 is presented (UI, UX), using the programmatic implementation 301, to the student's 113 electronic device 112, 114. The captured content 410 is processed 450 so that the high-frequency words and phrases are highlighted 411. The high-frequency words and phrases are defined by the pareto distribution 16. A pre-defined threshold, being either a word count or a percentage, is defined. All of the words or phrases which exceed the pre-defined threshold are high-frequency words and phrases. If the threshold is a word-count, the invention can take anywhere from the 500 to 1000 most used words and phrases in the target language as high-frequency words and phrases. If the threshold is a percentage, the invention can take anywhere from the top 5% to top 25% of the most frequently used words and phrases as the high-frequency words and phrases.

The highlighting 411 can take many forms: displaying the high-frequency word with bold text (see e.g., 411 “HIGH-FREQUENCY’; changing the color of the high-frequency word (see e.g., 411, “HIGHLIGHTED”; creating a highlight on the background adjacent to the high-frequency word (see e.g., 411, “GRAMMATICAL”; and italicizing the high-frequency word (see e.g., 411, “PARETO”, inter alia.

The programmatic implementation 301 processes and tracks 451 the user interaction with the captured 410 and highlighted 411 content, calculating success rates and exposure 412. The user's success rates and exposure 412 are processed 452 and shown to the user through the UI, UX 413. The user success rates 412 are processed 453 with a machine-learning algorithm via natural language processing (“NLP”) 414, freeing the user from the task of checking their success rates and proficiency. The processed success rates 414 are fed to a module 454 of the programmatic implementation 301 that adjusts 415 the captured content 410 that is presented to the user 411 based off of the user's progress 413. The content adjusting 415 can take one of two implementations 455, 456. The exposure rate of high-frequency words and phrases to the user 113 can be increased or decreased based off the success rate 416. The new exposure rate 416 can then be fed back 481 to the captured content 410. The highlighting of high-frequency words and phrases can also be modified to emphasize certain content to the user 417. The new highlighting scheme 417 can be fed back 480 to the captured content 410.

I claim:

1. A descriptivist language learning method comprising
creating a guideline document, identifying conversation topics in a target language;
recording a conversation, which complies with the guideline document, between at least two individuals fluent in the target language, wherein the individuals in the conversation are referred to as Native-speakers;
wherein the conversation is comprised of a plurality of non-trivial words and phrases;
transcribing the conversation in the target language;
translating the conversation in to a base language;
segmenting the transcribed and translated versions of the conversation, into snippets, so that each snippet lasts at least thirty seconds and no more than five minutes in duration;
creating a concordance of the translated and segmented conversation, wherein the concordance is an alphabetical listing of non-trivial words and phrases of the target language contained in the translated and segmented conversation, along with a reference to the passage in which the word or phrase occurs;
creating a pareto distribution from the concordance,
wherein the pareto distribution identifies the frequency with which the non-trivial words and phrases appear in the transcribed and segmented conversation;
wherein the non-trivial words and phrases are rank ordered in terms of frequency of occurrence;
wherein a frequency threshold is defined for the pareto distribution; and
wherein the words appearing more often than the pre-defined threshold are referred to as high-frequency words and phrases;
analyzing the transcribed and segmented conversation, using the pareto distribution and concordance, to ascertain the snippets within which the high-frequency words and phrases occur;
teaching a student, fluent in the base language, but not the target language, by presenting snippets, within which the high-frequency words and phrases occur, in language learning activities,
wherein the language learning activities are at least one of fill-in-the-blank, presented in the target language; multiple choice presented in the target language; match-the-word with one column in the target language and one column in the base language; and change the gender presented in the target language.

2. The descriptivist language learning method of claim 1, wherein the target language is exactly one of the 26 Most Spoken Languages as defined by the 2017 edition of ETHNOLOGUE: LANGUAGES OF THE WORLD, published by SIL International.

3. The descriptivist language learning method of claim 2, wherein the base language is exactly one of the 26 Most Spoken Languages as defined by the 2017 edition of ETHNOLOGUE: LANGUAGES OF THE WORLD, published by SIL International.

4. The descriptivist language learning method of claim 3, wherein high-frequency words and phrases are highlighted during language learning activities.

5. The descriptivist language learning method of claim 4, wherein highlighting occurs by making high-frequency words and phrases bold.

6. The descriptivist language learning method of claim 4, wherein highlighting occurs by making high-frequency words and phrases italicized.

7. The descriptivist language learning method of claim 4, wherein highlighting occurs by making the text of the high-frequency words and phrases a different color than the rest of the text.

8. The descriptivist language learning method of claim 4, wherein highlighting occurs by making the background adjacent to and behind the high-frequency words and phrases a different color than the background for the rest of the text.

9. The descriptivist language learning method of claim 4, wherein the pre-defined threshold for the high-frequency words is based on a countable number of non-trivial words.

10. The descriptivist language learning method of claim 9, wherein the pre-defined threshold is less than five hundred (500) words.

11. The descriptivist language learning method of claim 9, wherein the pre-defined threshold is exactly five hundred (500) words.

12. The descriptivist language learning method of claim 9, wherein the pre-defined threshold is more than five hundred (500) words but less than one thousand (1000) words.

13. The descriptivist language learning method of claim 4, wherein the pre-defined threshold for the high-frequency words is based on a percentage of non-trivial words.

14. The descriptivist language learning method of claim 13, wherein the pre-defined threshold is less than 10% (ten percent).

15. The descriptivist language learning method of claim 13, wherein the pre-defined threshold is exactly 10% (ten percent).

16. The descriptivist language learning method of claim 13, wherein the pre-defined threshold is more than 10% (ten percent) but less than 25% (twenty-five percent).

17. The descriptivist language learning method of claim 4, wherein all of the snippets are between one and three minutes in duration.

18. A descriptivist language learning system comprising
a plurality of Native-speakers, fluent in a target language;
at least one student wishing to learn the target language;
at least one student electronic device, comprised of a processor, a memory element that has a first non-transitory computer readable medium, an input means, a communication means allowing the at least one student device to send and receive information;
a server comprised of a memory element that has a second non-transitory computer readable medium, a processor, and a communication means;
an audio recording means;
a set of conversation guidelines; and
at least one computer readable instruction set, called an application, capable of
recording a conversation in a target language between the plurality of Native-speakers, which complies with the conversation guidelines;
wherein the conversation is comprised of a plurality of non-trivial words and phrases;
transcribing the conversation in the target language;
translating the conversation in to a base language;
segmenting the transcribed and translated versions of the conversation, into snippets, so that each snippet lasts at least thirty seconds and no more than five minutes in duration;
creating a concordance of the translated and segmented conversation, wherein the concordance is an alphabetical listing of non-trivial words and phrases of the target language contained in the translated and segmented conversation, along with a reference to the passage in which the word or phrase occurs;
creating a pareto distribution from the concordance,
wherein the pareto distribution identifies the frequency with which the non-trivial words and phrases appear in the transcribed and segmented conversation;
phrases in terms of frequency of occurrence;
wherein a frequency threshold is defined for the pareto distribution; and
wherein the words appearing more often than a pre-defined threshold are referred to as high-frequency words and phrases;
analyzing the transcribed and segmented conversation, using the pareto distribution and concordance, to ascertain the snippets within which the high-frequency words and phrases occur;
teaching a student, fluent in the base language, but not the target language, by presenting snippets within which the high-frequency words and phrases in language learning activities,
wherein the language learning activities are at least one of fill-in-the-blank, presented in the target language; multiple choice presented in the target language; match-the-word with one column in the target language and one column in the base language; and change the gender presented in the target language.

19. The descriptivist language learning system of claim 18, wherein the student electronic device is a cellphone.

20. The descriptivist language learning system of claim 18, wherein the student electronic device is a computer.

21. The descriptivist language learning system of claim 18, wherein the student electronic device is a tablet.

22. The descriptivist language learning system of claim 18, wherein the student electronic device is a wearable piece of electronics.

23. The descriptivist language learning system of claim 19, wherein at least one application is resident on the server.

24. The descriptivist language learning system of claim 23, wherein at least one application is resident on the student's electronic device.

25. The descriptivist language learning system of claim 24, wherein the application on the server and the application on the student's electronic device interact over a communications network.

26. The descriptivist language learning system of claim 25, wherein the communications network is a cellular network.

27. The descriptivist language learning system of claim 26, wherein the communications network is the internet.

28. The descriptivist language learning system of claim 27, wherein the communications network is a hybrid of a cellular network and the internet.

29. The descriptivist language learning system of claim 18 wherein all of the at least on applications are resident on a cloud server, wherein a cloud server is a vendorized server available over the internet.

30. The descriptivist language learning system of claim 29 wherein the at least one application is presented as a series of web pages.

31. The descriptivist language learning system of claim 30 wherein the student's electronic device is capable of accessing the web pages of the at least one application.

32. The descriptivist language learning system of claim 18, wherein the target language is exactly one of the 26 Most Spoken Languages as defined by the 2017 edition of ETHNOLOGUE: LANGUAGES OF THE WORLD, published by SIL International.

33. The descriptivist language learning system of claim 32, wherein the base language is exactly one of the is exactly one of the 26 Most Spoken Languages as defined by the 2017 edition of ETHNOLOGUE: LANGUAGES OF THE WORLD, published by SIL International.

34. The descriptivist language learning method of claim 33, wherein high-frequency words and phrases are highlighted during language learning activities.

35. The descriptivist language learning method of claim 34, wherein highlighting occurs by making high-frequency words and phrases bold.

36. The descriptivist language learning method of claim 35, wherein highlighting occurs by making high-frequency words and phrases italicized.

37. The descriptivist language learning method of claim 36, wherein highlighting occurs by making the text of the high-frequency words and phrases a different color than the rest of the text.

38. The descriptivist language learning method of claim 37, wherein highlighting occurs by making the background adjacent to and behind the high-frequency words and phrases a different color than the background for the rest of the text.

39. The descriptivist language learning method of claim 38, wherein the pre-defined threshold for the high-frequency words is based on a countable number of non-trivial words.

40. The descriptivist language learning method of claim 39, wherein the pre-defined threshold is less than five hundred (500) words.

41. The descriptivist language learning method of claim 39, wherein the pre-defined threshold is exactly five hundred (500) words.

42. The descriptivist language learning method of claim 39, wherein the pre-defined threshold is more than five hundred (500) words but less than one thousand (1000) words.

43. The descriptivist language learning method of claim 34, wherein the pre-defined threshold for the high-frequency words is based on a percentage of non-trivial words.

44. The descriptivist language learning method of claim 43, wherein the pre-defined threshold is less than 10% (ten percent).

45. The descriptivist language learning method of claim 43, wherein the pre-defined threshold is exactly 10% (ten percent).

46. The descriptivist language learning method of claim 43, wherein the pre-defined threshold is more than 10% (ten percent) but less than 25% (twenty-five percent).
